(19) United States
(12) Patent Application Publication
(10) Pub. No.: US 2026/0300656 A1
(43) Pub. Date: Oct. 1, 2026

(54) RADIO FREQUENCY IDENTIFICATION (RFID) DEVICE COMMUNICATIONS

(71) Applicant: QUALCOMM Incorporated, San Diego, CA (US)

(72) Inventors: Ahmed ELSHAFIE, San Diego, CA (US); Wei YANG, San Diego, CA (US); Yuchul KIM, San Diego, CA (US); Zhikun WU, Beijing (CN); Linhai HE, San Diego, CA (US); Huilin XU, Temecula, CA (US); Kianoush HOSSEINI, San Diego, CA (US)

(21) Appl. No.: 18/874,561

(22) PCT Filed: Aug. 13, 2022
(86) PCT No.: PCT/CN2022/112335

§ 371 Date: Dec. 12, 2024

(51) Int. Cl. G06K 7/10; H04W 4/80

(52) U.S. Cl. CPC G06K 7/10366; H04W 4/80

(57) ABSTRACT

Certain aspects are directed to a method for wireless communication at an RF source. In some examples, the method may include outputting, for transmission to a first radio frequency identification (RFID) device, a request for one or more parameters used by the first RFID device for wireless communication. In some examples, the method may include obtaining, from the first RFID device, a response comprising an indication of the one or more parameters. In some examples, the method may include outputting, for transmission to the first RFID device, coding information based on the one or more parameters, wherein the coding information enables communication between or among

### BACKGROUND

### Technical Field

The present disclosure generally relates to communication systems, and more particularly, to communications between radio frequency identification (RFID) devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus configured for wireless communication, including: a memory including instructions; and one or more processors configured to execute the instructions and cause the apparatus to: output, for transmission to a first radio frequency identification (RFID) device, a request for one or more parameters used by the first RFID device for wireless communication; obtain, from the first RFID device, a response including an indication of the one or more parameters; and output, for transmission to the first RFID device, coding information based on the one or more parameters, wherein the coding information enables communication between or among the first RFID device and at least one of the apparatus or a second RFID device.

In some aspects, the techniques described herein relate to an apparatus configured for wireless communication, including: a memory including instructions; and one or more processors configured to execute the instructions and cause the apparatus to: obtain, from a first radio frequency identification (RFID) device, a request for one or more parameters used by the apparatus for wireless communication; output, for transmission to the first RFID device, a response including an indication of the one or more parameters; and obtain, from the first RFID device, coding information based on the communication parameters, the coding information for configuring the apparatus for communication with one or more of the first RFID device and a second RFID device.

In some aspects, the techniques described herein relate to a method for wireless communication at network node, including: outputting, for transmission to a first radio frequency identification (RFID) device, a request for one or more parameters used by the first RFID device for wireless communication; obtaining, from the first RFID device, a response including an indication of the one or more parameters; and outputting, for transmission to the first RFID device, coding information based on the one or more parameters, wherein the coding information enables communication between or among the first RFID device and at least one of the network node or a second RFID device.

In some aspects, the techniques described herein relate to a method for wireless communication at a first radio frequency identification (RFID) device, including: obtaining, from a second RFID device, a request for one or more parameters used by the first RFID device for wireless communication; outputting, for transmission to the second RFID device, a response including an indication of the one or more parameters; and obtaining, from the second RFID device, coding information based on the communication parameters, the coding information for configuring the first RFID device for communication with one or more of the second RFID device or a third RFID device.

In some aspects, the techniques described herein relate to network node, including: means for outputting, for transmission to a first radio frequency identification (RFID) device, a request for one or more parameters used by the first RFID device for wireless communication; means for obtaining, from the first RFID device, a response including an indication of the one or more parameters; and means for outputting, for transmission to the first RFID device, coding information based on the one or more parameters, wherein the coding information enables communication between or among the first RFID device and at least one of the network node or a second RFID device.

In some aspects, the techniques described herein relate to a first radio frequency identification (RFID) device, including: means for obtaining, from a second RFID device, a request for one or more parameters used by the first RFID device for wireless communication; means for outputting, for transmission to the second RFID device, a response including an indication of the one or more parameters; and means for obtaining, from the second RFID device, coding information based on the communication parameters, the coding information for configuring the first RFID device for communication with one or more of the second RFID device and a third RFID device.

In some aspects, the techniques described herein relate to a non-transitory computer-readable medium having instructions stored thereon that, when executed by a network node, cause the network node to perform operations, including: outputting, for transmission to a first radio frequency identification (RFID) device, a request for one or more parameters used by the first RFID device for wireless communication; obtaining, from the first RFID device, a response including an indication of the one or more parameters; and outputting, for transmission to the first RFID device, coding information based on the one or more parameters, wherein the coding information enables communication between or among the first RFID device and at least one of the network node or a second RFID device.

In some aspects, the techniques described herein relate to a non-transitory computer-readable medium having instructions stored thereon that, when executed by a first RFID device, cause the first RFID device to perform operations, including: obtaining, from a second RFID device, a request for one or more parameters used by the first RFID device for wireless communication; outputting, for transmission to the second RFID device, a response including an indication of the one or more parameters; and obtaining, from the second RFID device, coding information based on the communication parameters, the coding information for configuring the first RFID device for communication with one or more of the second RFID device and a third RFID device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example monolithic (e.g., aggregated) base station and architecture of a distributed radio access network (RAN).

FIG. 5 is a block diagram illustrating an example disaggregated base station architecture.

FIG. 6 is a block diagram conceptually illustrating a network including a radio frequency (RF) source (e.g., a network node), a radio frequency identifier (RFID) tag, and an RFID reader.

FIG. 7 is a call-flow diagram illustrating example communications between a network node and an RFID tag.

FIG. 8 is a block diagram illustrating a conceptual representation of an integrated circuit of an RFID tag.

FIG. 9 is a diagram illustrating an example of grouped RFID tags in a wireless communications network.

FIG. 10 is a flowchart of a method of wireless communication.

FIG. 11 is a diagram illustrating an example of a hardware implementation for an example apparatus.

FIG. 12 is a flowchart of a method of wireless communication.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Certain aspects are directed to radio frequency identification (RFID) devices such as radio frequency (RF) sources, RFID tags, and RFID readers. RF sources may include any source of a transmitted RF signal, such as a network node (e.g., base station or a disaggregated part of a base station, such as a remote radio unit (RU), or a user equipment (UE)). An RFID readers may also be an RF source and may be a full duplex device configured to transmit an RF signal and simultaneously receive a backscattered version of the transmitted signal. The RF signal may be defined as a command signal (e.g., a command for writing data to the RFID tag). For example, an RF source or RF reader may transmit a signal containing code to an RFID tag, wherein the code is configured to command the RFID tag perform an operation or to write data to tag memory. For example, the data may provide the RFID tag with codebook information (e.g., how information bits “0” and “1” are represented) for modulating a transmitted signal where a set of bits (e.g., 000) in a transmitted signal represent “0” and another set of bits (e.g., 1111) represent “1.” Similarly, codebook information may also provide the RFID tag with a set of bits representing “0” and “1” for backscattering (e.g., a codebook used for a command transmitted to a tag could be different from a codebook used by the tag for backscattering). The RF signal may also be defined as a read code element, where the RF source or RF reader transmits a signal to the RFID tag with coding to use for backscattering a signal. For example, the RFID tag may be configured to receive a transmitted signal and use the signal to power its own RF front end. In some examples, an “RFID tag” as used herein may include a user equipment (UE) that is equipped with an RFID tag at least partially powered by the UE and at least partially configured based on an indication/configuration from a network (e.g., base station) or another UE. The UE can be read/programed by RFID tag source, RFID tag reader, gNB, or combination thereof. In some examples, an “RFID reader” may include a UE configured for transmitting signaling to an RFID tag and receiving a backscattered signal in response, or transmitting a command to an RFID tag to program the tag. In some examples, the RFID tag is a passive internet of things (IOT) device or zero-power IOT (ZP-IOT) device.

A signal transmitted from an RF source or RFID reader may cause the RFID tag to switch off reflection (e.g., switch off a backscatter capability) when the RF signal is a command signal. Conversely, the transmitted signal may cause the RFID tag to switch on reflection (e.g., use the backscatter capability) when the RF signal is a read code element. For example, a transmitted bit of “1” may switch off reflection at the RFID tag, while a transmitted bit of “0” may switch reflection on.

An RFID tag may decode or modulate a transmitted signal received from an RF source or an RFID reader in different ways. For example, to modulate one or more bits without or after channel encoding (where 1 bit is represented by few bits), the RFID tag may use amplitude shift keying (ASK), on-off keying (OOK), pulse-position modulation (PPM), pulse code modulation (PCM), pulse width modulation (PWM), Manchester modulation, Chirp-based modulation, frequency-shift keying (FSK), or any other suitable techniques for signal modulation. This information of which modulation/demodulation is supported by RFID tag is signaled as part of capability exchange. In some cases, such capability can change based on power requirements or reliability requirements since some modulation/demodulation schemes can be more power consuming than others. In some examples, when RFID tag is equipped with a battery and is performing power saving, it can use less power consuming modulation (for transmission) or for demodulation (for reception), this can be based on configuration from RF source or RF reader or gNB or combination thereof.

In some cases, a UE might be equipped with two radios: a main radio (e.g., NR or LTE or both) and an RFID tag radio. The RFID tag radio which is used at low power state modes at the UE, or based on UE decision, or based partially on configuration from network unit (e.g., gNB). In such cases, the coding configuration can take place similar to RFID radio in previous sections. In some other cases, the gNB/RF source/RF reader or controller can communicate with the main radio of the UE with coding configuration, perhaps when the main radio is on active state or RRC connected mode, then the main radio configures the RFID tag radio. In other cases, the main radio can generate the coding sequences (DFT, Zadoff, and other) based on some configured IDs, then store them for the RFID tag radio in a memory unit, such that the RFID tag radio can use them for communication. In some examples, when there are updates in coding/modulation/configuration, etc., and the main radio is OFF or inactive/IDLE RRC mode or in sleep mode, the communication may take place between RFID tag radio and the RF source/RF reader/gNB, etc., directly.

However, an RFID tag may have very limited memory (e.g., memory capacity on the order of kilobytes) to store configuration information as such modulation/demodulation information and codebook information. Moreover, RFID tags may not be capable of generating configuration information on their own. Such RFID tags cannot, for example, use a scrambling ID, generate pseudorandom codes (e.g., the RFID tag does not include a pseudorandom generator), generate Gold codes, generate discrete Fourier transform (DFT) matrices/vectors, or channel encoders (e.g., polar or low-density parity-check (LDPC) code).

Accordingly, aspects of the disclosure are directed to techniques for transmitting configuration information to the RFID tag to configure the RFID tag (e.g., replace old configurations or to initialize the RFID tag). Thus, according to certain aspects, an RF source or RFID reader may configure an RFID tag and/or update a configuration of the RFID tag. By updating the configuration information of an RFID tag, the interference between tags and/or tag readers may be avoided (e.g., one or more readers may each be assigned a set of sequences (e.g., codebooks) for serving a set of assigned tags). Moreover, if the RFID signals coexist with cellular signals, separation of sequences may reduce interference between the RFID and cellular signals.

In certain aspects, an RF source or RFID reader may configure the RFID tag with a codebook for “0” and “1” by transmitting the codebook information to the tag as a command. However, an RFID tag may have a small memory or digital storage (e.g., on the order of kilobytes) and may only be configurable with codebook information that is sized within the RFID tag memory. Thus, an RFID tag may be configured with a coding capability and a memory capability for storing codebook information. The memory capability may relate to a maximum memory (e.g., a size of the memory) allocated for coding information bits (e.g., “1” and “0”). For example, the memory capability for “0” may be N bits (e.g., the maximum number of bits that can be allocated for information bit “0” is N), and the memory capability for “1” may also be N bits (e.g., the maximum number of bits that can be allocated for information bit “1” is N). In this example, the maximum number of bits is the same for both 0 and 1, but in other examples the number of bits for one information bit may be different relative to the other information bit. A coding capability may relate to the type of signal modulation that the RFID tag is capable of: e.g., channel coding, or sequential-based coding.

In some cases, the coding information can include waveform information (e.g., one or more of a type of single carrier, a type of multi-carrier, etc.). The waveform information may be used by an RF reader and/or an RFID tag for data decoding. In some examples, a charging rate and/or energy harvesting efficiency (RF-to-DC energy conversion) may be a function of a waveform used for commands and/or continuous wave (CW) transmissions. In some cases, a multi-carrier waveform can have higher energy transfer to an EH device over a single tone signal.

In some examples, a modulation scheme used to modulate a signal for powering the RFID tag can impact/change the amount of energy transferred. From a data point of view, an RFID tag command/query reception reliability or quality could depend on a waveform of one type (e.g., single carrier) vs a waveform of a second type (e.g., multi-carrier/OFDM) based on channel conditions (e.g., Doppler spread, Doppler shift, Delay spread, etc.). Similarly, for an RF reader, because the RF reader will decode the response/backscattered signal, the reliability of the backscattered signal under a first type waveform (e.g., single-carrier waveform) could be less or higher than reliability of a backscattered signal under a second type waveform (e.g., OFDM/multi-tone waveform). Hence, reliability at he RF reader, the RFID tag, and the charging rate at RFID tag, there could be some preference of waveform over time (e.g., based on channel conditions such as Doppler spread/shift, delay spread, etc.). Thus, adaptation of a waveform used in an RFID network may be based on an RFID observed/experienced reliability for decoding commands/queries, an experienced charging rate at RFID tag, and/or a reliability of an RFID reader for decoding “response/backscattered” signals from RFID tag.

Accordingly, an RF source or RFID reader may transmit a wireless signal to the tag, wherein the wireless signal is configured to query the RFID tag about one or more of the memory capability and the coding capability of the tag. In response, the tag may transmit a backscatter signal that comprises one or more of: (i) an indication of the max memory for coding (e.g., maximum memory allocation per information bit, or total memory allocation), (ii) an indication of a coding scheme the tag is capable of using (e.g., an indication of a granularity of generating and processing of the complex numbers it can generate in case of a backscattering response from the tag) and a decoding (e.g., in case of receiving a command from the RF source or RFID reader that does not need to be backscattered)), and/or (iii) an indication a tag ability to generate a codebook such as DFT, Gold, m-sequence, Zadoff, Walsh, Reed Solomon, etc., (e.g., allowing the RF source or RFID reader to provide the tag with a certain column index to use for coding a backscatter response and/or decoding a transmission from the RF source or RFID reader). Thus, the tag may indicate its capability to read (e.g., decode a received signal), its capability to encode, and its capability to store information. In other words, whether the tag can indicate whether it has a capability that allows it to receive, decode, and read a coded signal (e.g., command) from another device, and details related to the capability (e.g., how backscattered signals are modulated, how received signals are decoded, an amount of memory allocated to codebook information and/or each information bit).

The RF source or RFID reader may then program the RFID tag with a certain codebook and that is a size that the tag has sufficient memory to store, or may indicate a certain codebook and/or certain column index for a modulation scheme that the RFID tag is capable of using, and that is a size that the tag has sufficient memory to store.

In certain aspects, an RFID tag may be configured with a default coding configuration during a manufacturing phase or during an initial communication with an RF source or RFID reader. The default coding may support initial communications with the source or reader, and may be defined by: (i) the max memory for coding, (ii) the coding scheme the tag is capable of using for a backscattered transmission from the tag, and/or (iii) the tag's ability to generate a codebook such as DFT, gold, m-sequence, Zadoff, Walsh, Reed Solomon, etc. If the reader or source configures the tag with the default coding configuration in an initial communication, the reader/source may transmit an indication of the coding scheme to the tag as a command (e.g., for writing the coding scheme to the tag).

In certain aspects, the tag may include a processing block configured to parse the data contained in a received signal from the source or reader. For example, the tag may receive a command code element and/or a read code element, and convert the received signal to digital domain (e.g., via an analog-to-digital converter (ADC)). The tag may then split the digital domain signal into N-bit length (e.g., where the N-bit length corresponds to the memory capability for information bits 1 and 0) sections and determines whether each section corresponds to a 1 or a 0. If a memory bit length for one information bit is a different length than the other information bit, the tag may split the received digital domain signal according to both lengths to determine which length and corresponding bit makes results in a proper decoding.

In certain aspects, the RF source may configure the reader if the reader is configured differently from the RF source. This is because the reader needs to know the codebook (e.g., how 0 and 1 are represented) used by the RF source and the tag in order to read a backscattered signal from the tag. Thus, the RF source may configure the reader with this information so that the reader can read a backscattered signal from a tag. In some examples, a reader may be a network node or a user equipment (UE). In such an example, the reader may be configured by the base station (e.g., centralized unit (CU) and/or distributed unit (DU)) or by another UE (e.g., via sidelink communication).

In certain aspects, the source may transmit a wireless signal to the reader, wherein the wireless signal is configured to query the reader about one or more of the memory capability or the coding capability of the reader (e.g., similar to the communications described above with regard to the source/reader and the tag). In response, the reader may transmit a signal to the source that comprises one or more of: (i) an indication of a coding scheme the reader is capable of using (e.g., an indication of a granularity of generating and processing of the complex numbers it can generate in a transmission to the tag) or a decoding (e.g., in case of receiving a command code element or a read code element from the RF source, or receiving a backscattered signal from the tag), and/or (ii) an indication of the reader's ability to generate a codebook such as DFT, Gold, m-sequence, Zadoff, Walsh, Reed Solomon, etc. for communications between the reader and either of the tag and/or the source. Thus, the reader may transmit an indication of its capability to read (e.g., decode a received signal) and its capability to encode. In some examples, the reader may also provide its capability to store information.

In certain aspects, an RF source or a network node (e.g., base station or component of a base station) may manage tags according to a grouping. For example, the RF source or network node may for a first group of one or more tags, and a second group of one or more tags. The RF source or network node may then configure the tags of groups with different sequences (e.g., orthogonal/non-orthogonal sequences) and/or channel coding (e.g., phase-shift keying) used by the RF source and reader(s) associated with those groups. Interference between groups may be reduced by configuring different groups with different communication configurations.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

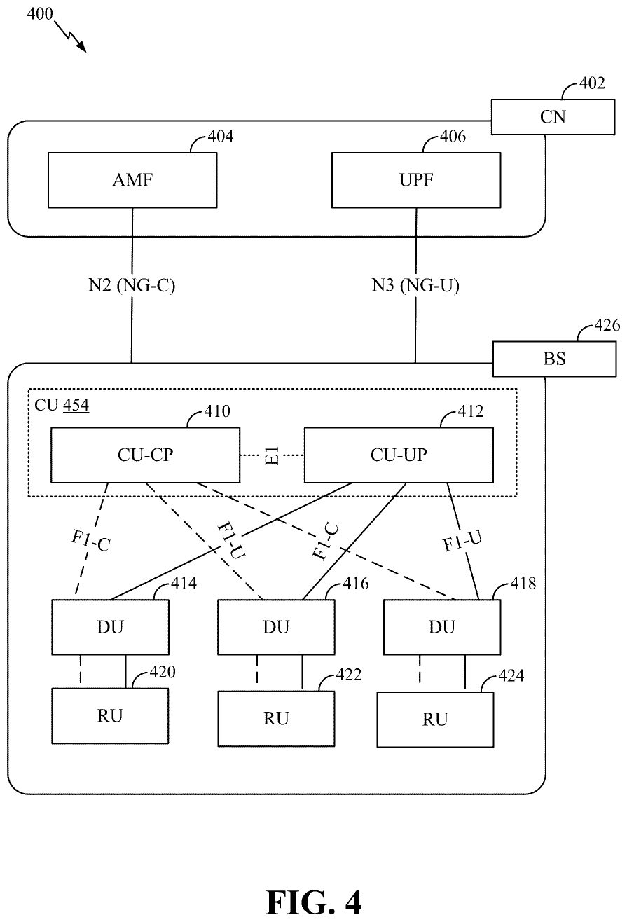

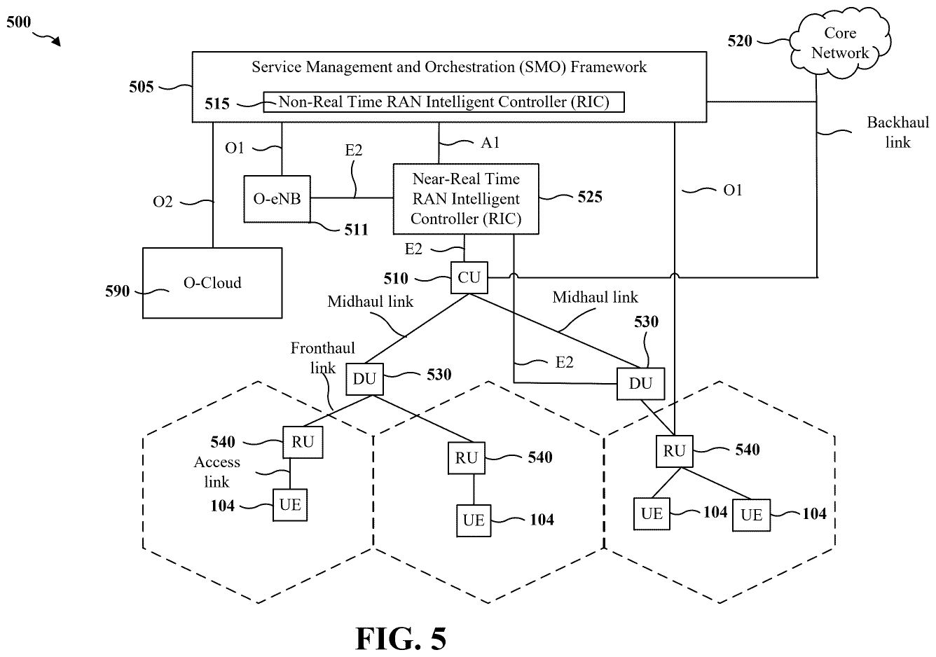

Throughout the disclosure, a “network node” may be used to refer to a base station or a component of the base station. A base station can be implemented as an aggregated base station (e.g., FIG. 4) comprising one or more separated components, as an aggregated base station (e.g., FIG. 5), an integrated access and backhaul (IAB) node, a relay node, etc. Accordingly, a network node may refer to one or more of a central unit (CU), a distributed unit (DU), a radio unit (RU), a near-real time (near-RT) radio access network (RAN) intelligent controller (RIC), or a non-real time (non-RT) RIC.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

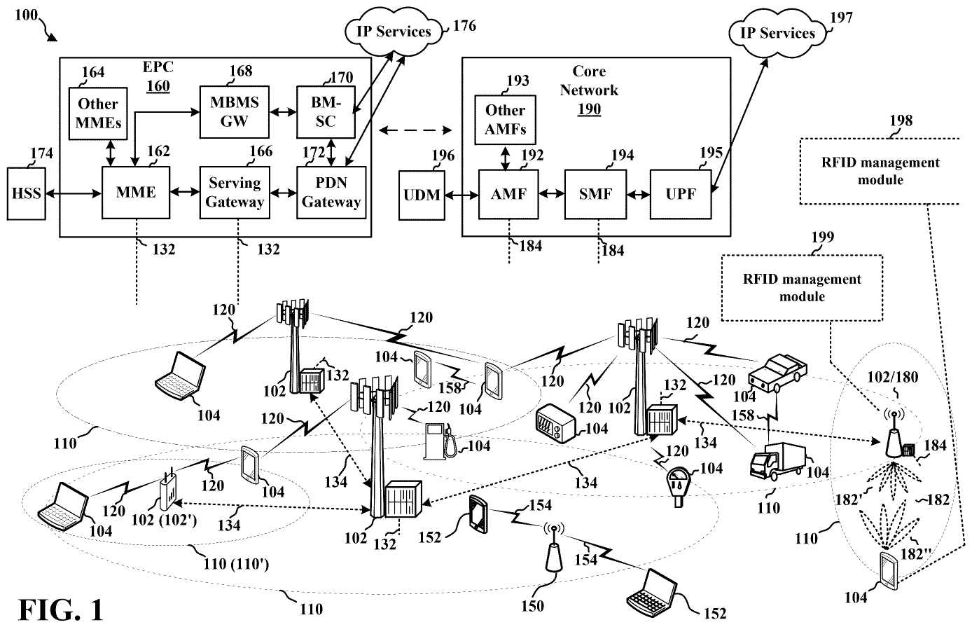

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the base station 102/180 may include an RFID management module 199. In some examples, the RFID management module 199 may be configured to output, for transmission to a first radio frequency identification (RFID) device, a request for one or more parameters used by the first RFID device for wireless communication; obtain, from the first RFID device, a response comprising an indication of the one or more parameters; and output, for transmission to the first RFID device, coding information based on the one or more parameters, wherein the coding information enables communication between or among the first RFID device and at least one of the apparatus or a second RFID device. In some examples, the base station 102/180 may be configured as an RF source or a network node.

In certain aspects, the UE 104 may include an RFID management module 198. In some examples, the RFID management module 198 may be configured to obtain, from a first radio frequency identification (RFID) device, a request for one or more parameters used by the apparatus for wireless communication; output, for transmission to the first RFID device, a response comprising an indication of the one or more parameters; and obtain, from the first RFID device, coding information based on the communication parameters, the coding information for configuring the apparatus for communication with one or more of the first RFID device and a second RFID device. In this example, the UE 104 may be configured as an RFID reader or an RFID tag.

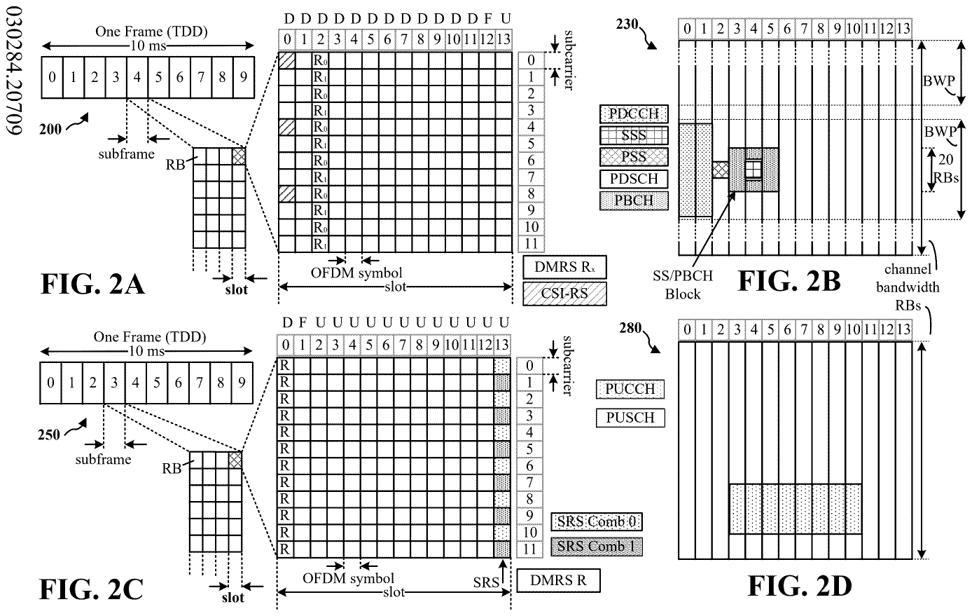

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

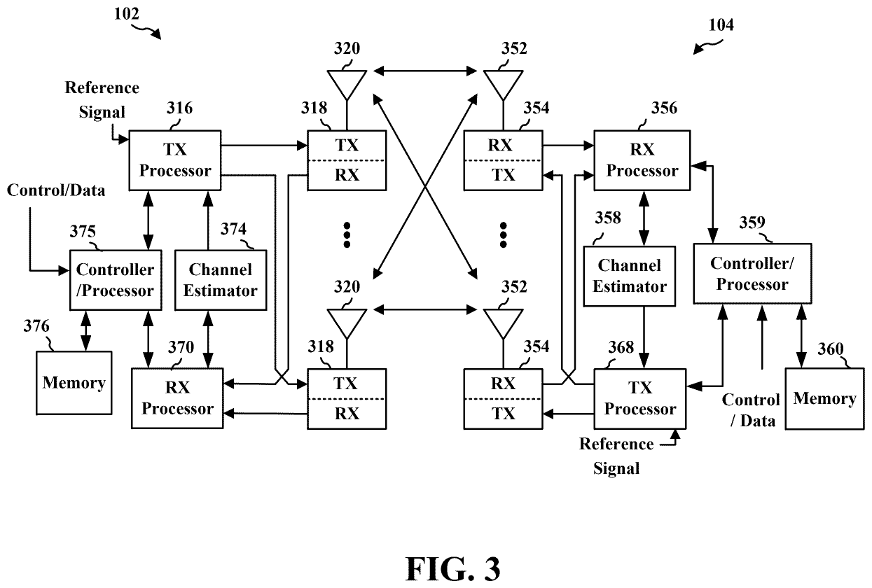

FIG. 3 is a block diagram of a base station 102/180 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

FIG. 4 illustrates an example monolithic (e.g., aggregated base station) architecture of a distributed RAN 400, which may be implemented in the wireless communications system and an access network 100 illustrated in FIG. 1. As illustrated, the distributed RAN 400 includes core network (CN) 402 and a base station 426.

The CN 402 may host core network functions. CN 402 may be centrally deployed. CN 402 functionality may be offloaded (e.g., to advanced wireless services (AWS)), in an effort to handle peak capacity. The CN 402 may include an AMF 404 and a UPF 406. The AMF 404 and UPF 406 may perform one or more of the core network functions.

The base station 426 may communicate with the CN 402 (e.g., via a backhaul interface). The base station 426 may communicate with the AMF 404 via an N2 (e.g., NG-C) interface. The base station 426 may communicate with the UPF 406 via an N3 (e.g., NG-U) interface. The base station 426 may include a central unit-control plane (CU-CP) 410, one or more central unit-user planes (CU-UPs) 412, one or more distributed units (DUs) 414-418, and one or more radio units (RUs) 420-424.

The CU-CP 410 may be connected to one or more of the DUs 414-418. The CU-CP 410 and DUs 414-418 may be connected via a F1-C interface. As shown in FIG. 4, the CU-CP 410 may be connected to multiple DUs, but the DUs may be connected to only one CU-CP. Although FIG. 4 only illustrates one CU-UP 412, the base station 426 may include multiple CU-UPs. The CU-CP 410 selects the appropriate CU-UP(s) for requested services (e.g., for a UE). The CU-UP(s) 412 may be connected to the CU-CP 410. For example, the CU-UP(s) 412 and the CU-CP 410 may be connected via an E1 interface. The CU-UP(s) 412 may be connected to one or more of the DUs 414-418. The CU-UP(s) 412 and DUs 414-418 may be connected via a F1-U interface. As shown in FIG. 4, the CU-CP 410 may be connected to multiple CU-UPS, but the CU-UPs may be connected to only one CU-CP 410.

A DU, such as DUs 414, 416, and/or 418, may host one or more TRP(s) (transmit/receive points, which may include an edge node (EN), an edge unit (EU), a radio head (RH), a smart radio head (SRH), or the like). A DU may be located at edges of the network with radio frequency (RF) functionality. A DU may be connected to multiple CU-UPs that are connected to (e.g., under the control of) the same CU-CP (e.g., for RAN sharing, radio as a service (RaaS), and service specific deployments). DUs may be configured to individually (e.g., dynamic selection) or jointly (e.g., joint transmission) serve traffic to a UE. Each DU 414-416 may be connected with one of RUs 420/422/424.

The CU-CP 410 may be connected to multiple DU(s) that are connected to (e.g., under control of) the same CU-UP 412. Connectivity between a CU-UP 412 and a DU may be established by the CU-CP 410. For example, the connectivity between the CU-UP 412 and a DU may be established using bearer context management functions. Data forwarding between CU-UP(s) 412 may be via a Xn-U interface.

The distributed RAN 400 may support fronthauling solutions across different deployment types. For example, the RAN 400 architecture may be based on transmit network capabilities (e.g., bandwidth, latency, and/or jitter). The distributed RAN 400 may share features and/or components with LTE. For example, the base station 426 may support dual connectivity with NR and may share a common fronthaul for LTE and NR. The distributed RAN 400 may enable cooperation between and among DUs 414-418, for example, via the CU-CP 412. An inter-DU interface may not be used. Logical functions may be dynamically distributed in the distributed RAN 400.

FIG. 5 is a block diagram illustrating an example disaggregated base station 500 architecture. The disaggregated base station 500 architecture may include one or more CUs 510 that can communicate directly with a core network 520 via a backhaul link, or indirectly with the core network 520 through one or more disaggregated base station units (such as a near real-time (RT) RIC 525 via an E2 link, or a non-RT RIC 515 associated with a service management and orchestration (SMO) Framework 505, or both). A CU 510 may communicate with one or more DUs 530 via respective midhaul links, such as an F1 interface. The DUs 530 may communicate with one or more RUs 540 via respective fronthaul links. The RUs 540 may communicate with respective UEs 104 via one or more radio frequency (RF) access links. In some implementations, the UE 104 may be simultaneously served by multiple RUs 540.

Each of the units, i.e., the CUS 510, the DUs 530, the RUs 540, as well as the near-RT RICs 525, the non-RT RICs 515 and the SMO framework 505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 510 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 510. The CU 510 may be configured to handle user plane functionality (i.e., central unit-user plane (CU-UP)), control plane functionality (i.e., central unit-control plane (CU-CP)), or a combination thereof. In some implementations, the CU 510 can be logically split into one or more CU-UP units and one or more CU-CP units. The CU-UP unit can communicate bidirectionally with the CU-CP unit via an interface, such as the E1 interface when implemented in an O-RAN configuration. The CU 510 can be implemented to communicate with the DU 530, as necessary, for network control and signaling.

The DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 530 may further host one or more low PHY layers. Each layer (or module) can be implemented with an interface configured to communicate signals with other layers (and modules) hosted by the DU 530, or with the control functions hosted by the CU 510.

Lower-layer functionality can be implemented by one or more RUs 540. In some deployments, an RU 540, controlled by a DU 530, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 540 can be implemented to handle over the air (OTA) communication with one or more UEs 104. In some implementations, real-time and non-real-time aspects of control and user plane communication with the RU(s) 540 can be controlled by the corresponding DU 530. In some scenarios, this configuration can enable the DU(s) 530 and the CU 510 to be implemented in a cloud-based RAN architecture, such as a virtual RAN (vRAN) architecture.

The SMO Framework 505 may be configured to support RAN deployment and provisioning of non-virtualized and virtualized network elements. For non-virtualized network elements, the SMO framework 505 may be configured to support the deployment of dedicated physical resources for RAN coverage requirements, which may be managed via an operations and maintenance interface (such as an O1 interface). For virtualized network elements, the SMO framework 505 may be configured to interact with a cloud computing platform (such as an open cloud (O-cloud) 590) to perform network element life cycle management (such as to instantiate virtualized network elements) via a cloud computing platform interface (such as an O2 interface). Such virtualized network elements can include, but are not limited to, CUs 510, DUs 530, RUs 540 and near-RT RICs 525. In some implementations, the SMO framework 505 can communicate with a hardware aspect of a 4G RAN, such as an open eNB (O-eNB) 511, via an O1 interface. Additionally, in some implementations, the SMO Framework 505 can communicate directly with one or more RUs 540 via an O1 interface. The SMO framework 505 also may include the non-RT RIC 515 configured to support functionality of the SMO Framework 505. The non-RT RIC 515 may be configured to include a logical function that enables non-real-time control and optimization of RAN elements and resources, artificial intelligence/machine learning (AI/ML) workflows including model training and updates, or policy-based guidance of applications/features in the near-RT RIC 525. The non-RT RIC 515 may be coupled to or communicate with (such as via an A1 interface) the near-RT RIC 525. The near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the near-RT RIC 525.

In some implementations, to generate AI/ML models to be deployed in the near-RT RIC 525, the non-RT RIC 515 may receive parameters or external enrichment information from external servers. Such information may be utilized by the near-RT RIC 525 and may be received at the SMO Framework 505 or the non-RT RIC 515 from non-network data sources or from network functions. In some examples, the non-RT RIC 515 or the near-RT RIC 525 may be configured to tune RAN behavior or performance. For example, the non-RT RIC 515 may monitor long-term trends and patterns for performance and employ AI/ML models to perform corrective actions through the SMO Framework 505 (such as reconfiguration via 01) or via creation of RAN management policies (such as A1 policies).

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

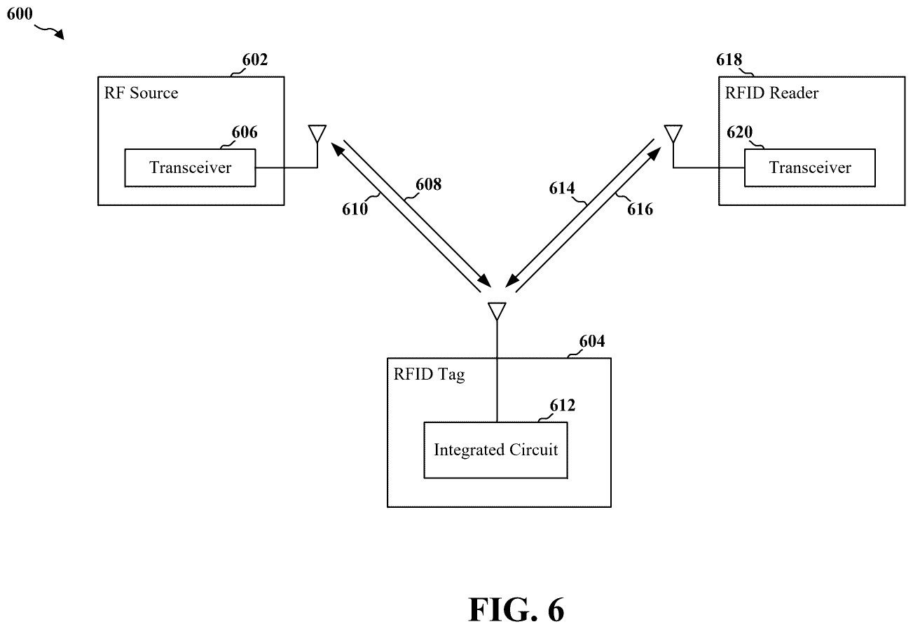

FIG. 6 is a block diagram conceptually illustrating a network 600 including an RF source 602 (e.g., a network node), and RFID tag 604, and an RFID reader 618. The source 602 includes a first transceiver 606 and the reader 618 includes a second transceiver 620, each of which is communicatively coupled to one or more antenna elements. The tag 604 includes an integrated circuit 612 communicatively coupled to an antenna.

Wireless communications between the source 602 and the tag 604 include a first forward link 608 and a first backscatter link 610. Similarly, wireless communications between the reader 618 and the tag 604 include a second forward link 614 and a second backscatter link 616. Typically, a passive tag is powered by the first/second forward link signal. For example, the tag 604 may include a diode and a capacitor for receiving and storing the energy received via the forward link. In another example, the tag 604 may use instantaneous power received from forward link to modulate the received signal and transmit the backscatter signal if the tag 604 has no capacitor. In another example, the tag may include a battery to power modulation of the backscatter signal.

The forward link signal may include one or more of a continuous wave (e.g., ultra-high frequency (UHF) signal for powering up the tag 604, or a modulated signal used to transmit a command code element or a read code element. For example, the source 602 or the reader 618 may first transmit a continuous wave (CW) signal for a first time duration (e.g., 400 μs) to power up the tag 604. The source 602 or the reader 618 may then transmit a command/packet (e.g., a modulated wave) that provides information to the tag 604 as well as power. The source 602 or the reader 618 may then continue transmitting a CW to the tag in order to maintain the power at the tag 604 so that the tag can transmit a backscatter response. The tag 604 may support both channel coding (e.g., polar, LDPC, error correction codes, etc.) and sequence base coding (e.g., DFT, Zadoff, m-sequence, Gold code, Reed Solomon, etc.).

### Example Communications with an RFID Tag

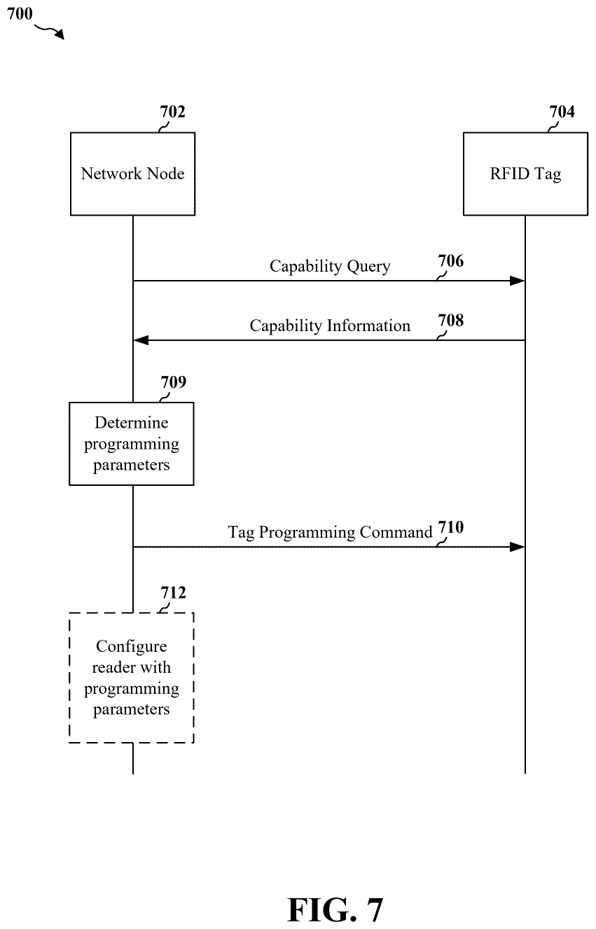

FIG. 7 is a call-flow diagram illustrating example communications 700 between a network node 702 (wherein the network node 702 may represent one or both of an RF source and an RFID reader) and an RFID tag 704.

Initially, the network node 702 may transmit, to the tag 704, a first communication 706 including a request (e.g., capability query) for one or more parameters used by the tag 704 for wireless communication. The request may be a command signal, configured to trigger a response from the tag 704. In some examples, the one or more parameters may include a size of a memory of the RFID tag 704, a modulation capability of the RFID tag 704, and a demodulation capability of the RFID tag 704.

The tag 704 may be configured with a maximum memory capability for storing coding related information. The memory capability may relate to a maximum memory (e.g., a size of the memory) allocated for coding information bits (e.g., “1” and “0”). For example, the memory capability for “0” may be N bits (e.g., the maximum number of bits that can be allocated for information bit “0” is N), and the memory capability for “1” may also be N bits (e.g., the maximum number of bits that can be allocated for information bit “1” is N). In this example, the maximum number of bits is the same for both 0 and 1, but in other examples the number of bits for one information bit may be different relative to the other information bit. In some examples, the size of the memory is indicative of memory resources of the RFID tag allocated for coding information element (e.g., an amount of resources that can be used to store codebook information that defines how “1” and “0” are to be encoded/decoded).

The tag 704 may also be configured with a modulation and demodulation capability (e.g., a coding capability). A coding capability may relate to the type of signal modulation/demodulation that the RFID tag 704 is capable of (e.g., a code processing capability): e.g., channel coding, or sequential-based coding. As such, the coding capability may also be defined by a maximum number (e.g., M) representative of a maximum size of coding sequence per bit that the tag 704 can process from a received signal (e.g., a maximum size of coding sequence per bit that the tag 704 can decode). The coding capability may also be defined by a granularity of complex numbers the tag 704 is capable of generating (e.g., for backscatter transmission) and/or decoding and processing (e.g., for decoding and processing a signal received from the network node 702). The coding capability may also be defined by the tag's 704 capability to generate and/or decode a codebook/sequence (e.g., discrete Fourier transform (DFT) matrices/vectors generation, Gold codes generation, m-sequence, Zadoff, etc.), channel encoders (e.g., polar, low-density parity-check (LDPC) code, etc.). As such, a coding capability of the tag 704 may be defined by which sequences and/or codes and/or modulation/demodulation (e.g., ASK, OOK, PPM, PCM, PWM, Manchester modulation, Chirp-based modulation, FSK, etc.) the tag is using or is capable of using. Thus, the command query may include a request for one or more of a coding capability and/or a memory capability of the tag 704.

The RFID tag 704 may transmit, in response to the capability query of the first communication 706, a second communication 708 that includes an indication of the tag's 704 capabilities (e.g., capability information). The indication of the tag's 704 capabilities may include one or more of a size of the memory of the tag 704, a modulation capability of the tag 704, and/or a demodulation capability of the tag 704. The capability information may include any one or more of the information defining the tag's 704 capabilities described above in reference to the first communication 706. Thus, the tag 704 may provide the network node 702 with any of the information related to the tag's 704 capabilities described above.

At a first process 709, the network node 702 may determine one or more of: (i) a demodulation codebook that the tag 704 can use for decoding/demodulating command signals and read signals that are transmitted to the tag 704, or (ii) a modulation codebook that the tag 704 can use for encoding/modulating command signals and read signals that are transmitted to the tag 704 so that the tag 704 can modulate and backscatter the read signals to the network node 702. The demodulation/modulation codebook may provide the tag 704 with bit information indicating a codebook for encoding/decoding “1” and “0” bits.

In some examples, the codebook for encoding/decoding may be determined based on a codebook that the network node 702 uses (e.g., a codebook used by the RF source for encoding/decoding). In some examples, the codebook for encoding/decoding may be determined based on a group to which the tag 704 belongs. In this example, the network node 702 may determine different codebooks for different groups, where all the tags of one group use the same codebook. In another example, the codebook may be randomly selected based on at least one of an RF source ID (e.g., L1/L2/L3 ID, hardware (HW) ID, or combination thereof), RF reader ID (e.g., L1/L2/L3 ID, HW ID, or combination thereof), RFID tag ID (e.g., L1/L2/L3 ID, HW ID, or combination thereof), priority of data to be communicated to or from RFID tags, RFID tag class(es)/type(s), and/or zone ID. In some examples, a mapping/hashing function may use one or more of those inputs (e.g., the IDs) to generate a pool of sequences/codebooks to be used with a group of RFID tags and then determine the sequence/codebook that is to be used by an RFID tag.

In a third communication 710, the network node 702 may transmit a tag programming command comprising coding information based on the capability information. The coding information may be configured to enable communication between or among the tag 704 and one or more of the RF source and RFID reader. For example, the coding information may be determined by the first process 709, and may be the same coding information used by the RF source and/or RFID reader for encoding/decoding communications. The RFID tag 704 may then store the coding information and apply the coding information for future communications (e.g., decoding received command elements and read elements) and/or encoding backscattered signals.

In certain aspects, the tag programming command is configured to indicate too the tag 704 what sequence (e.g., DFT, Gold, Walsh, Reed Solomon, etc.) represents “0” and what sequence represents “1.” In some examples, the sequences may be explicitly signaled to the tag 704 via the third communication 710. In some examples, the network node 702 may assign a number of resources per bit (e.g., resources 010 assigned to “0,” and resources 1101 assigned to “1”). In some examples, the number of resources assigned per bit may be based on the memory capability of the tag 704. That is, if the tag 704 is configured to support a sequence of size N for each bit, then an N-sized sequence may be assigned by the network node and provided to the tag 704 for bit “0,” and another N-sized sequence may be assigned and provided for bit “1.” It should be noted that the sequences may be differently sized.

In certain aspects, the tag 704 may be configured with default coding information. That is, at a manufacturing stage or during an initial communication between the tag 704 and the network node 702, the tag 704 may be configured with a default modulation codebook and/or default demodulation codebook. In some examples, the default coding information may depend on a class (e.g., defined by a memory size of the tag 704, whether the tag is battery/capacitor powered, encoding/decoding capabilities, etc.) of the RFID tag 704. Thus, a network node 702 may be configured to determine default coding of the tag 704 based on an indication of the class of the tag 704. For example, in the first communication 706, the network node 702 may instead transmit a request for an indication of a class to which the tag 704 belongs. Based on the class, the network node 702 may determine one or more of the default coding information of the tag 704 and/or the coding and memory capabilities of the tag 704. In another example, the network node 702 may determine (e.g., in the first process 709) the programming parameters based on the class of the tag 704. For example, the network node 702 may determine default coding information and transmit the coding information to the tag 704 to be used as a default. In some examples, the coding information may be mapped to a class of the tag 704 by a wireless communication standard.

At a second process 712, the network node 702 (e.g., in this case an RF source) may configure an RFID reader with the programming parameters provided to the tag 704. For example, in a read command, when the RFID reader is to read a backscatter signal transmitted by the RFID tag (e.g., based on a signal transmitted by the RF source), the reader may need to be configured with the same codebook used by the RF source and the tag. Thus, if the RF source and/or tag is configured with a codebook that is different from the reader, the RF source may transmit the programming parameters to the reader.

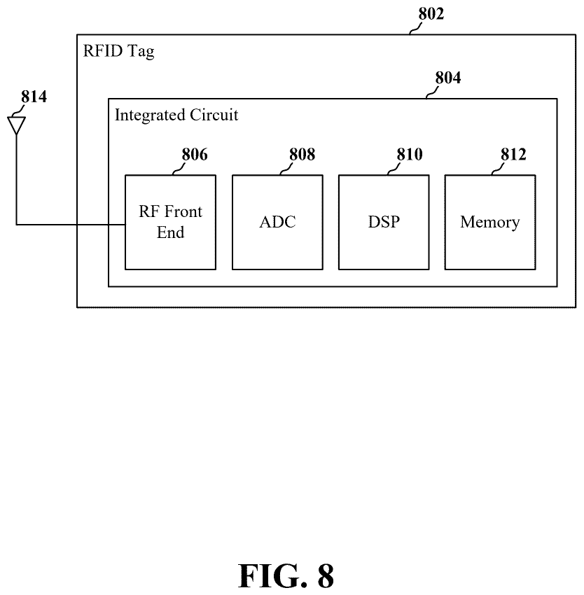

FIG. 8 is a block diagram illustrating a conceptual representation of an integrated circuit 804 of an RFID tag 802. The integrated circuit 804 is coupled to an antenna element 814, and includes an RF front end 806, an analog to digital converter (ADC) 808, a digital signal processor (DSP) 810, and a memory 812.

As discussed above, the tag 802 may be configured with a codebook for encoding/decoding wireless signals. The codebook may provide an indication of a number of bits (e.g., N) mapped to an information bit (e.g., 1 or 0). Each number of bits may indicate a coding rate in the case of BPSK. For example, if the allocated memory is N bits for an information bit (e.g., wherein one information bit can have at least N bits stored in memory, the tag 802 may store the following in memory:

$$0 = {a}_{1} {a}_{2} … {a}_{N}$$

$$1 = {b}_{1} {b}_{2} … {b}_{N}$$

where aᵢ and bᵢ are binary values that correspond to a digital domain of a signal received by the tag 802 from the network node. In this example, the number of bits (e.g., N) mapped to each of 0 and 1 is the same. It should be noted, however, that the number of bits may be different for each bit.

The DSP 810 may be configured to receive, from the ADC 808, a digital representation of a signal received from a network node (e.g., an RF source or RFID reader). For example, the DSP 810 may receive 001111001111. For purposes of illustration, assuming that the allocated memory is N=3 bits for both of 0 and 1, and that 0=001 and 1=111, the DSP 810 may be configured to split the received digital domain signal into discrete segments according to N, and determine whether each segment corresponds to 0 or 1. In the example of 001111001111, the DSP 810 may split the signal into four segments: 001, 111, 001, 111. According to the codebook stored on the tag 802, the DSP 810 may translate the four segments to their corresponding information bits as follows: 0 1 0 1.

It should be noted that the tag 802 may indicate whether it has a capability to perform the aforementioned DSP 810 processes in a capability information signal to the network node (e.g., second communication 708 of FIG. 7).

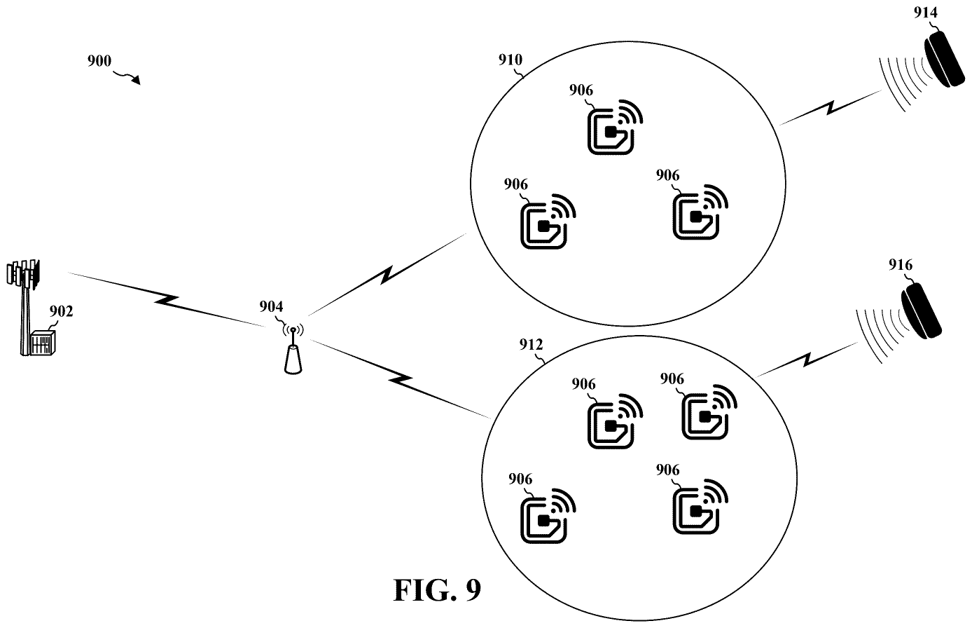

FIG. 9 is a diagram illustrating an example of grouped RFID tags in a wireless communications network 900. Here the network 900 include a network node 902 (e.g., a base station), an RF source 904, a first group 910 of RFID tags 906, a second group 912 of RFID tags 906, a first RFID reader 914, and a second RFID reader 916. The RFID tags 906 may be grouped according to geographic location (e.g., grouped according to a location, area, or zone).

Here, the network node 902 may distribute codebooks including different sequences or codes to be used by the RF source 904 and readers 914/916. The RF source 904 may then provide the codebooks according to the groups. For example, the RF source 904 may provide a first codebook to the first reader 914 and the tags 906 in the first group 910, and a second codebook to the second reader 916 and the tags 906 in the second group 912. Alternatively, the RF source 904 may randomly select codebooks to be distributed to the tags 906 and readers 914/916. In one example, the random selection may be based on identifiers associated with RF sources (e.g., in a case of multiple RF sources), identifiers associated with the first reader 914 and the second reader 916, identifiers associated with the tags 906, classes of the tags 906, and/or identifiers associated with the first group 910 and the second group 912.

In some examples, the RF source 904 may determine distribution of the codebooks among the readers and groups without help/assignments from the network node 902. However, in another example, the RF source 904 may receive the codebooks from the network node 902, along with information indication how the codebooks are to be distributed among the readers and groups. In this example, the network node 902 may assign a first codebook to the first reader 914 and the first group 910, and assign a second codebook to the second reader 916 and the second group 912. When the network node 902 transmits the first and second codebooks to the RF source 904, the transmission may also include an indication of the assignments.

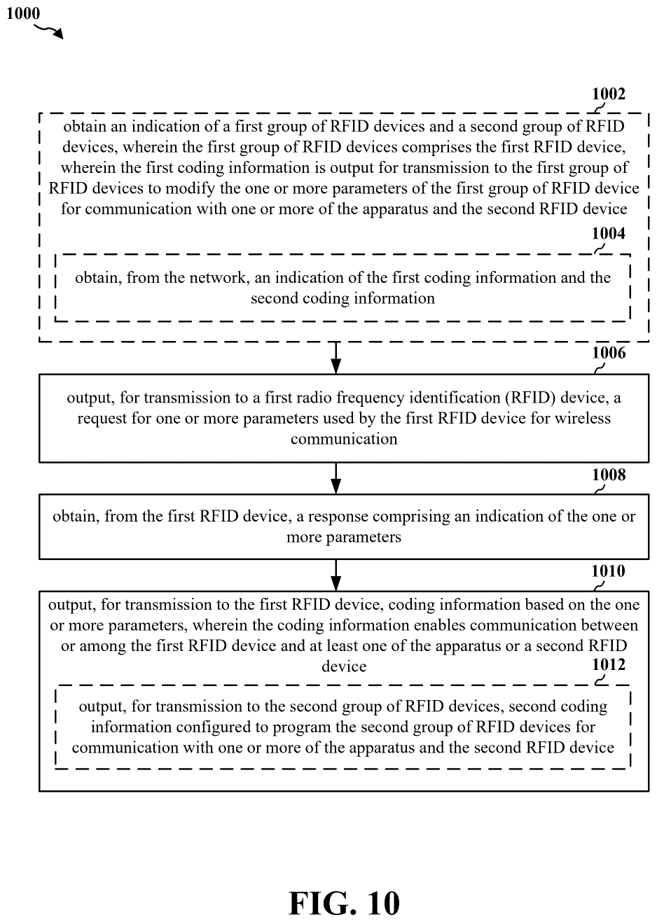

FIG. 10 is a flowchart 1000 of a method of wireless communication. The method may be performed by a user equipment and/or network node (e.g., the base station 102 of FIG. 1; the network node 902 of FIG. 9; the RF source 904 of FIG. 9; the apparatus 1102).

At 1002, the network node may optionally obtain an indication of a first group of RFID devices and a second group of RFID devices, wherein the first group of RFID devices comprises the first RFID device, wherein the first coding information is output for transmission to the first group of RFID devices to modify the one or more parameters of the first group of RFID device for communication with one or more of the apparatus and the second RFID device. For example, 1002 may be performed by a receiving component 1142. In this example, the network node may be implemented as an RF source. Here, as described in FIG. 9, the RF source may receive coding information (e.g., codebooks) from a base station as well as an indication of grouping of one or more of RFID tags and/or readers. The RF source may also receive an indication of an assignment of coding information to certain groups.

At 1004, the network node may optionally obtain, from the network, an indication of the first coding information and the second coding information. For example, 1004 may be performed by a receiving component 1142. In this example, the RF source may receive the codebooks associated with a first coding information (e.g., coding information corresponding to a first group) and a second coding information (e.g., coding information corresponding to a second group).

At 1006, the network node may output, for transmission to a first radio frequency identification (RFID) device, a request for one or more parameters used by the first RFID device for wireless communication. For example, 1006 may be performed by a transmitting component 1140. The network node may be implemented as an RF source or an RFID reader. Here, the network node may query one or more RFID tags with a transmission requesting capability information about the tags, as described in the first communication 706 of FIG. 7.

At 1008, the network node may obtain, from the first RFID device, a response comprising an indication of the one or more parameters. For example, 1008 may be performed by the receiving component 1142. The RFID device may be implemented as either an RFID reader or an RFID tag. Here, the RFID device may respond to the network node query with a transmission indicating one or more capabilities of the RFID device, as illustrated in the second communication 708 of FIG. 7.

At 1010, the network node may output, for transmission to the first RFID device, coding information based on the one or more parameters, wherein the coding information enables communication between or among the first RFID device and at least one of the apparatus or a second RFID device. For example, 1010 may be performed by a transmitting component 1140. Here, the network node may determine a codebook to be used by the first and second RFID devices, and transmit the codebook to the devices to enable them to perform RFID operations (e.g., operations illustrated in FIG. 6) as illustrated in the first process 709 and third communication 710 of FIG. 7.

At 1012, the network node may optionally output, for transmission to the second group of RFID devices, second coding information configured to program the second group of RFID devices for communication with one or more of the apparatus and the second RFID device. For example, 1012 may be performed by a transmitting component 1140. Here, in the case of a grouping of RFID devices, the network node may transmit different coding information to different groups, as illustrated and described in FIG. 9.

In certain aspects, the first RFID device is an RFID tag, and wherein the indication of the one or more parameters comprises an indication of one or more of: a size of a memory of the RFID tag, a modulation capability of the RFID tag, and a demodulation capability of the RFID tag.

In certain aspects, the second RFID device is an RFID reader, and wherein the coding information comprises one or more of: a demodulation codebook for demodulating command signals and read signals output for transmission from the apparatus; and a modulation codebook for backscattering the read signals to the second RFID device.

In certain aspects, the request for the one or more parameters is a command signal.

In certain aspects, the size of the memory is indicative of memory resources of the RFID tag allocated for coding information elements.

In certain aspects, the first RFID device is an RFID reader, and wherein the indication of the one or more parameters comprises an indication of a decoding capability of the RFID reader.

In certain aspects, the coding information comprises a demodulation codebook for demodulating backscatter signals obtained from an RFID tag.

In certain aspects, the coding information is configured to modify the one or more communication parameters of the first RFID device.

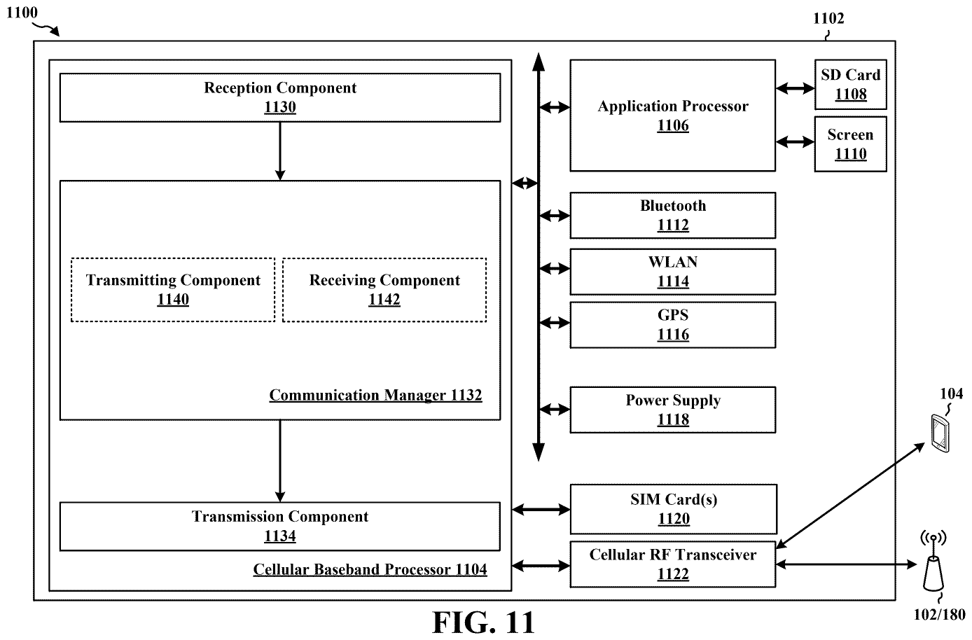

FIG. 11 is a diagram 1100 illustrating an example of a hardware implementation for an apparatus 1102. The apparatus 1102 may be implemented as a network node (e.g., a base station RF source, RFID reader) and includes a baseband unit 1104 (also referred to as a modem). The baseband unit 1104 may be coupled to one or more of a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 104 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1302 may be the entire UE (e.g., see 104 of FIG. 3) and include the aforediscussed additional modules of the apparatus 1102.

The communication manager 1132 includes a transmitting component 1140 configured to output, for transmission to a first radio frequency identification (RFID) device, a request for one or more parameters used by the first RFID device for wireless communication; output, for transmission to the first RFID device, coding information based on the one or more parameters, wherein the coding information enables communication between or among the first RFID device and at least one of the apparatus or a second RFID device; and output, for transmission to the second group of RFID devices, second coding information configured to program the second group of RFID devices for communication with one or more of the apparatus and the second RFID device, e.g., as described in connection with 1006, 1010, and 1012 of FIG. 10.

The communication manager 1132 further includes a receiving component 1142 configured to obtain an indication of a first group of RFID devices and a second group of RFID devices, wherein the first group of RFID devices comprises the first RFID device, wherein the first coding information is output for transmission to the first group of RFID devices to modify the one or more parameters of the first group of RFID device for communication with one or more of the apparatus and the second RFID device; obtain, from the network, an indication of the first coding information and the second coding information; and obtain, from the first RFID device, a response comprising an indication of the one or more parameters, e.g., as described in connection with 1002, 1004, and 1008 of FIG. 10.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes means for obtaining an indication of a first group of RFID devices and a second group of RFID devices, wherein the first group of RFID devices comprises the first RFID device, wherein the first coding information is output for transmission to the first group of RFID devices to modify the one or more parameters of the first group of RFID device for communication with one or more of the apparatus and the second RFID device; means for obtaining, from the network, an indication of the first coding information and the second coding information; means for outputting, for transmission to a first radio frequency identification (RFID) device, a request for one or more parameters used by the first RFID device for wireless communication; means for obtaining, from the first RFID device, a response comprising an indication of the one or more parameters; means for outputting, for transmission to the first RFID device, coding information based on the one or more parameters, wherein the coding information enables communication between or among the first RFID device and at least one of the apparatus or a second RFID device; and means for outputting, for transmission to the second group of RFID devices, second coding information configured to program the second group of RFID devices for communication with one or more of the apparatus and the second RFID device.

The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

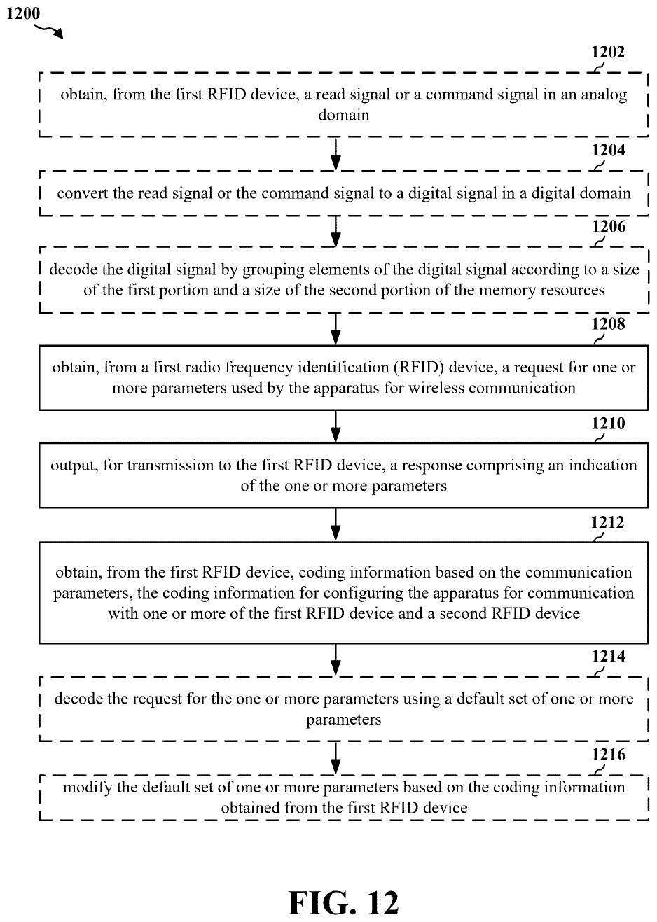

FIG. 12 is a flowchart 1200 of a method of wireless communication. The method may be performed by an apparatus (e.g., an RFID tag 604/704/802; the apparatus 1302). At 1202, the apparatus may optionally obtain, from the first RFID device, a read signal or a command signal in an analog domain. For example, 1202 may be performed by a receiving component 1342. The first RFID device may be an RF source or an RFID reader. Here, the apparatus may obtain a read signal (e.g., a signal that the apparatus is configured to use for a backscatter transmission) or a command signal (e.g., a signal that the apparatus uses to receive and store information carried by the command signal, but does not backscatter).

At 1204, the apparatus may optionally convert the read signal or the command signal to a digital signal in a digital domain. For example, 1204 may be performed by an analog to digital converter (ADC) component 1344. Here, the apparatus may include an ADC configured to receive an analog wireless signal from an RS source or an RFID reader, and convert the analog signal into a digital domain.

At 1206, the apparatus may optionally decode the digital signal by grouping elements of the digital signal according to a size of the first portion and a size of the second portion of the memory resources. For example, 1206 may be performed by a digital signal processor (DSP) component 1346. Here, the apparatus may parse the digital domain signal by separating bits into segments according to a codebook for translating bits into information bits. For example, if the digital domain signal is 001111, and the codebook provides that 001 is a binary 0, and 111 is a binary 1, the apparatus may separate the signal into two segments (e.g., 001 and 111) and then convert each segment into the corresponding binary bit.

At 1208, the apparatus may obtain, from a first radio frequency identification (RFID) device, a request for one or more parameters used by the apparatus for wireless communication. For example, 1208 may be performed by a receiving component 1342. The first RFID device may be an RF source or an RFID reader. The first RFID device may be implemented as an RF source or an RFID reader. Here, the first RFID device may query one or more RFID tags with a transmission requesting capability information about the tags, as described in the first communication 706 of FIG. 7.

At 1210, the apparatus may output, for transmission to the first RFID device, a response comprising an indication of the one or more parameters. For example, 1210 may be performed by a transmitting component 1340. For example, the apparatus may respond to the query with a transmission indicating one or more capabilities of the apparatus, as illustrated in the second communication 708 of FIG. 7.

At 1212, the apparatus may obtain, from the first RFID device, coding information based on the communication parameters, the coding information for configuring the apparatus for communication with one or more of the first RFID device and a second RFID device. For example, 1212 may be performed by a receiving component 1342. Here, the first RFID device may determine a codebook to be used by the apparatus for communications with the first and/or second RFID devices. The first RFID device may transmit the codebook to the apparatus to enable it to perform RFID operations (e.g., operations illustrated in FIG. 6) as illustrated in the first process 709 and third communication 710 of FIG. 7.

At 1214, the apparatus may decode the request for the one or more parameters using a default set of one or more parameters. For example, 1214 may be performed by a DSP component 1346.

At 1216 the apparatus may modify the default set of one or more parameters based on the coding information obtained from the first RFID device. For example, 1216 may be performed by a modifying component 1348. Here, the apparatus may store the received parameters in a memory of the apparatus, thereby replacing previously stored parameters. The parameters may include codebook information.

In certain aspects, the indication of the one or more parameters comprises an indication of one or more of: a size of a memory of the apparatus, a modulation capability of the apparatus, and a demodulation capability of the apparatus.

In certain aspects, the size of the memory is indicative of memory resources of the apparatus allocated for coding both a first information element and a second information element, wherein a first portion of the memory resources is configured to store coding for the first information element, and wherein a second portion of the memory resources is configured to store coding for the second information element.

In certain aspects, the second RFID device is an RFID reader, and wherein the coding information comprises one or more of: a demodulation codebook for demodulating command signals and read signals obtained from the first RFID device; and a modulation codebook for backscattering the read signals to the second RFID device.

In certain aspects, the request for the one or more parameters is a command signal.

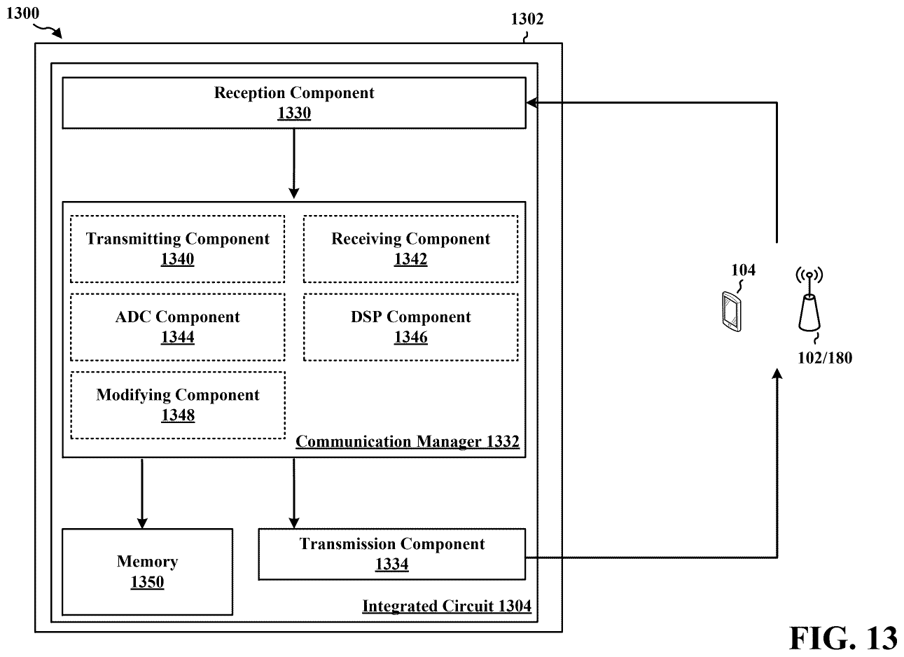

FIG. 13 is a diagram 1300 illustrating an example of a hardware implementation for an apparatus 1302. The apparatus 1302 is an RFID tag and includes an integrated circuit comprising an RF front end (e.g., reception component 1330 and transmission component 1334) and a memory 1350. The RF front end provides the apparatus with a capability to receive signals from an RF source and/or an RFID reader, and transmit backscattered signals in response. As illustrated, the UE 104 may be implemented as an RFID reader and/or an RF source.

The communication manager 1332 includes a transmitting component 1340 that is configured to output, for transmission to the first RFID device, a response comprising an indication of the one or more parameters; e.g., as described in connection with 1210.

The communication manager 1332 includes a receiving component 1342 that is configured to obtain, from the first RFID device, a read signal or a command signal in an analog domain; obtain, from a first radio frequency identification (RFID) device, a request for one or more parameters used by the apparatus for wireless communication; obtain, from the first RFID device, coding information based on the communication parameters, the coding information for configuring the apparatus for communication with one or more of the first RFID device and a second RFID device; e.g., as described in connection with 1202, 1208, and 1212.

The communication manager 1332 includes an ADC component 1344 configured to convert the read signal or the command signal to a digital signal in a digital domain; e.g., as described in connection with 1204.

The communication manager 1332 includes a DSP component 1346 configured to decode the digital signal by grouping elements of the digital signal according to a size of the first portion and a size of the second portion of the memory resources; and decode the request for the one or more parameters using a default set of one or more parameters; e.g., as described in connection with 1206 and 1214.

The communication manager 1332 includes a modifying component 1348 configured to modify the default set of one or more parameters based on the coding information obtained from the first RFID device; e.g., as described in connection with 1216.

The apparatus may include additional components that perform each of the blocks of the algorithm in the aforementioned flowchart of FIG. 12. As such, each block in FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the cellular baseband processor 1304, includes means for obtaining, from the first RFID device, a read signal or a command signal in an analog domain. Means for converting the read signal or the command signal to a digital signal in a digital domain. Means for decoding the digital signal by grouping elements of the digital signal according to a size of the first portion and a size of the second portion of the memory resources. Means for obtaining, from a first radio frequency identification (RFID) device, a request for one or more parameters used by the apparatus for wireless communication. Means for outputting, for transmission to the first RFID device, a response comprising an indication of the one or more parameters. Means for obtaining, from the first RFID device, coding information based on the communication parameters, the coding information for configuring the apparatus for communication with one or more of the first RFID device and a second RFID device. Means for decoding the request for the one or more parameters using a default set of one or more parameters. Means for modifying the default set of one or more parameters based on the coding information obtained from the first RFID device.

The aforementioned means may be one or more of the aforementioned components of the apparatus 1302 configured to perform the functions recited by the aforementioned means. As described supra, the apparatus 1302 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

### Additional Considerations

Means for receiving or means for obtaining may include a receiver (such as the receive processor 370) or an antenna(s) 320 of the BS 102 or the receive processor 356 or antenna(s) 352 of the UE 104 illustrated in FIG. 3. Means for transmitting or means for outputting may include a transmitter (such as the transmit processor 316) or an antenna(s) 320 of the BS 102 or the transmit processor 368 or antenna(s) 352 of the UE 102 illustrated in FIG. 3. Means for converting, means for decoding, and means for modifying may include a processing system, which may include one or more processors, such as the receive processor 370/356, the transmit processor 316/368, the TX MIMO processor 318/354, and/or the controller 375/359 of the BS 102 and the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a network node, comprising: outputting, for transmission to a first radio frequency identification (RFID) device, a request for one or more parameters used by the first RFID device for wireless communication; obtaining, from the first RFID device, a response comprising an indication of the one or more parameters; and outputting, for transmission to the first RFID device, coding information based on the one or more parameters, wherein the coding information enables communication between or among the first RFID device and at least one of the network node or a second RFID device.

Example 2 is the method of example 1, wherein the first RFID device is an RFID tag, and wherein the indication of the one or more parameters comprises an indication of one or more of: a size of a memory of the RFID tag, a modulation capability of the RFID tag, and a demodulation capability of the RFID tag.

Example 3 is the method of any of examples 1 and 2, wherein the second RFID device is an RFID reader, and wherein the coding information comprises one or more of: a demodulation codebook and waveform for demodulating command signals and read signals output for transmission from the network node; and a modulation codebook for backscattering the read signals to the second RFID device.

Example 4 is the method of any of examples 1-3 wherein the request for the one or more parameters is a command signal.

Example 5 is the method of example 2, wherein the size of the memory is indicative of memory resources of the RFID tag allocated for coding information elements.

Example 6 is the method of any of examples 1-5, wherein the first RFID device is an RFID reader, and wherein the indication of the one or more parameters comprises an indication of a decoding capability of the RFID reader.

Example 7 is the method of any of examples 1-6, wherein the coding information comprises a demodulation codebook for demodulating backscatter signals obtained from an RFID tag.

Example 8 is the method of any of examples 1-7, wherein the coding information is a first coding information, and wherein the method further comprises: obtaining an indication of a first group of RFID devices and a second group of RFID devices, wherein the first group of RFID devices comprises the first RFID device, wherein the first coding information is output for transmission to the first group of RFID devices to modify the one or more parameters of the first group of RFID device for communication with one or more of the network node and the second RFID device; and outputting, for transmission to the second group of RFID devices, second coding information configured to program the second group of RFID devices for communication with one or more of the network node and the second RFID device.

Example 9 is the method of example 8, wherein the indication of the first group and the second group is obtained from a network, and wherein the method further comprises: obtaining, from the network, an indication of the first coding information and the second coding information.

Example 10 is the method of any of examples 1-9, wherein the coding information is configured to modify the one or more communication parameters of the first RFID device.

Example 11 is method for wireless communication at a first radio frequency identification (RFID) device, comprising: obtaining, from a second RFID device, a request for one or more parameters used by the first RFID device for wireless communication; outputting, for transmission to the second RFID device, a response comprising an indication of the one or more parameters; and obtaining, from the second RFID device, coding information based on the communication parameters, the coding information for configuring the first RFID device for communication with one or more of the second RFID device or a third RFID device.

Example 12 is the method of example 11, wherein the indication of the one or more parameters comprises an indication of one or more of: a size of a memory of the first RFID device, a modulation capability of the first RFID device, and a demodulation capability of the first RFID device.

Example 13 is the method of example 12, wherein the size of the memory is indicative of memory resources of the first RFID device allocated for coding both a first information element and a second information element, wherein a first portion of the memory resources is configured to store coding for the first information element, and

wherein a second portion of the memory resources is configured to store coding for the second information element.

Example 14 is the method of example 13, further comprising: obtaining, from the second RFID device, a read signal or a command signal in an analog domain; converting the read signal or the command signal to a digital signal in a digital domain; and decoding the digital signal by grouping elements of the digital signal according to a size of the first portion and a size of the second portion of the memory resources.

Example 15 is the method of any of examples 11-14, further comprising: decoding the request for the one or more parameters using a default set of one or more parameters; and modifying the default set of one or more parameters based on the coding information obtained from the first RFID device.

Example 16 is the method of any of examples 11-15, wherein the third RFID device is an RFID reader, and wherein the coding information comprises one or more of: a demodulation codebook for demodulating command signals and read signals obtained from the second RFID device; and a modulation codebook for backscattering the read signals to the third RFID device.

Example 17 is the method of any of examples 11-16, wherein the request for the one or more parameters is a command signal.

Example 18 is a network node, comprising: a transceiver; a memory comprising instructions; and one or more processors configured to execute the instructions to cause the network node to perform a method in accordance with any one of examples 1-10, wherein the transceiver is configured to: transmit the request for one or more parameters; receive the response comprising the indication of the one or more parameters; and transmit coding information based on the one or more parameters.

Example 19 is an RFID device, comprising: a transceiver; a memory comprising instructions; and one or more processors configured to execute the instructions to cause the RFID device to perform a method in accordance with any one of examples 11-16, wherein the transceiver is configured to: receive the request for one or more parameters used by the apparatus for wireless communication; transmit the response; and receive coding information based on the communication parameters.

Example 20 is an apparatus for wireless communications, comprising means for performing a method in accordance with any one of examples 1-10.

Example 21 is an apparatus for wireless communications, comprising means for performing a method in accordance with any one of examples 11-16.

Example 22 is a non-transitory computer-readable medium comprising instructions that, when executed by an apparatus, cause the apparatus to perform a method in accordance with any one of examples 1-10.

Example 23 is a non-transitory computer-readable medium comprising instructions that, when executed by an apparatus, cause the apparatus to perform a method in accordance with any one of examples 11-16.

Example 24 is an apparatus for wireless communications, comprising: a memory comprising instructions; and one or more processors configured to execute the instructions to cause the apparatus to perform a method in accordance with any one of examples 1-10.

Example 25 is apparatus for wireless communications, comprising: a memory comprising instructions; and one or more processors configured to execute the instructions to cause the apparatus to perform a method in accordance with any one of examples 11-16.

What is claimed is:

1. An apparatus configured for wireless communication, comprising:
a memory comprising instructions; and
one or more processors configured to execute the instructions and cause the apparatus to:
output, for transmission to a first radio frequency identification (RFID) device, a request for one or more parameters used by the first RFID device for wireless communication;
obtain, from the first RFID device, a response comprising an indication of the one or more parameters; and
output, for transmission to the first RFID device, coding information based on the one or more parameters, wherein the coding information enables communication between or among the first RFID device and at least one of the apparatus or a second RFID device.

2. The apparatus of claim 1, wherein the first RFID device is an RFID tag, and wherein the indication of the one or more parameters comprises an indication of one or more of:
a size of a memory of the RFID tag,
a modulation capability of the RFID tag, and
a demodulation capability of the RFID tag.

3. The apparatus of claim 2, wherein the second RFID device is an RFID reader, and wherein the coding information comprises one or more of:
a demodulation codebook and waveform for demodulating command signals and read signals output for transmission from the apparatus; and
a modulation codebook for backscattering the read signals to the second RFID device.

4. The apparatus of claim 1, wherein the request for the one or more parameters is a command signal.

5. The apparatus of claim 2, wherein the size of the memory is indicative of memory resources of the RFID tag allocated for coding information elements.

6. The apparatus of claim 1, wherein the first RFID device is an RFID reader, and wherein the indication of the one or more parameters comprises an indication of a decoding capability of the RFID reader.

7. The apparatus of claim 1, wherein the coding information comprises a demodulation codebook for demodulating backscatter signals obtained from an RFID tag.

8. The apparatus of claim 1, wherein the coding information is a first coding information, and wherein the one or more processors are further configured to cause the apparatus to:
obtain an indication of a first group of RFID devices and a second group of RFID devices, wherein the first group of RFID devices comprises the first RFID device, wherein the first coding information is output for transmission to the first group of RFID devices to modify the one or more parameters of the first group of RFID device for communication with one or more of the apparatus and the second RFID device; and
output, for transmission to the second group of RFID devices, second coding information configured to program the second group of RFID devices for communication with one or more of the apparatus and the second RFID device.

9. The apparatus of claim 8, wherein the indication of the first group and the second group is obtained from a network, and wherein the one or more processors are further configured to cause the apparatus to:
obtain, from the network, an indication of the first coding information and the second coding information.

10. The apparatus of claim 1, wherein the coding information is configured to modify the one or more communication parameters of the first RFID device.

11. The apparatus of claim 1, further comprising a transceiver configured to:
transmit the request for the one or more parameters;
receive the response comprising the indication of the one or more parameters; and
transmit coding information based on the one or more parameters, wherein the apparatus is configured as a network node.

12. An apparatus configured for wireless communication, comprising:
a memory comprising instructions; and
one or more processors configured to execute the instructions and cause the apparatus to:
obtain, from a first radio frequency identification (RFID) device, a request for one or more parameters used by the apparatus for wireless communication;
output, for transmission to the first RFID device, a response comprising an indication of the one or more parameters; and
obtain, from the first RFID device, coding information based on the communication parameters, the coding information for configuring the apparatus for communication with one or more of the first RFID device and a second RFID device.

13. The apparatus of claim 12, wherein the indication of the one or more parameters comprises an indication of one or more of:
a size of a memory of the apparatus,
a modulation capability of the apparatus, and
a demodulation capability of the apparatus.

14. The apparatus of claim 13, wherein the size of the memory is indicative of memory resources of the apparatus allocated for coding both a first information element and a second information element, wherein a first portion of the memory resources is configured to store coding for the first information element, and wherein a second portion of the memory resources is configured to store coding for the second information element.

15. The apparatus of claim 14, wherein the one or more processors are further configured to cause the apparatus to:
obtain, from the first RFID device, a read signal or a command signal in an analog domain;
convert the read signal or the command signal to a digital signal in a digital domain; and
decode the digital signal by grouping elements of the digital signal according to a size of the first portion and a size of the second portion of the memory resources.

16. The apparatus of claim 12, the one or more processors are further configured to cause the apparatus to:
decode the request for the one or more parameters using a default set of one or more parameters; and
modify the default set of one or more parameters based on the coding information obtained from the first RFID device.

17. The apparatus of claim 12, wherein the second RFID device is an RFID reader, and wherein the coding information comprises one or more of:
a demodulation codebook for demodulating command signals and read signals obtained from the first RFID device; and
a modulation codebook for backscattering the read signals to the second RFID device.

18. The apparatus of claim 12, wherein the request for the one or more parameters is a command signal.

19. A first radio frequency identification (RFID) device configured for wireless communication, comprising:
a transceiver;
a memory comprising instructions; and
one or more processors configured to execute the instructions and cause the first RFID device to:
receive, via the transceiver from a second RFID device, a request for one or more parameters used by the first RFID device for wireless communication;
transmit, via the transceiver to the second RFID device, a response comprising an indication of the one or more parameters; and
receive, via the transceiver from the second RFID device, coding information based on the communication parameters, the coding information for configuring the first RFID device for communication with one or more of the second RFID device or a third RFID device.

20. The first RFID device of claim 19, wherein the indication of the one or more parameters comprises an indication of one or more of:
a size of a memory of the first RFID device,
a modulation capability of the first RFID device, or
a demodulation capability of the first RFID device.
